(19) United States
(12) Patent Application Publication
(10) Pub. No.: US 2016/0105049 A1
(43) Pub. Date: Apr. 14, 2016

(54) SOUND-ENHANCING STORAGE DEVICE

(71) Applicant: Mark W. SCHELLER, Lemoyne, PA (US)

(72) Inventor: Mark W. SCHELLER, Lemoyne, PA (US)

(21) Appl. No.: 14/878,725

(22) Filed: Oct. 8, 2015

Related U.S. Application Data
(60) Provisional application No. 62/061,955, filed on Oct. 9, 2014.

(51) Int. Cl. H02J 7/00; A45C 15/00; A45C 3/06; A45C 13/02; H04R 1/02; G10K 11/08

(52) U.S. Cl. CPC H02J 7/0044; H04R 1/026; G10K 11/08; A45C 3/06; A45C 13/02; A45C 15/00; A45C 2013/026; A45C 2200/10

(57) ABSTRACT

A storage device for storing an electronic device and amplifying sound emitted from the electronic device. The storage device includes a projection device that includes a surface having a recess, wherein the recess is configured to reflect sound emitted from an electronic device located adjacent to the recess to at least one area facing the surface. The storage device also includes an opening configured to allow for insertion of the electronic device into the recess such that the projection device is positioned in an interior portion of the storage device. The storage device may also include a light emitting portion configured to propagate light emitted from the electronic device, one or more external features for displaying light that light emitted by the electronic device, and at least one electrical component configured to provide power for charging the electronic device when the electronic device is placed in the recess.

### CROSS-REFERENCE TO RELATED APPLICATION

This application claims benefit of and priority to U.S. Provisional Application No. 62/061,955 entitled “Sound-Enhancing Storage Device,” filed Oct. 9, 2014, the disclosure of which is incorporated by reference herein in its entirety.

### BACKGROUND

Electronic devices, particularly mobile electronic devices such as smartphones, tablets, and the like, are increasingly used as a part of an everyday routine. Such electronic devices can be used for a wide range of purposes, such as for communication, entertainment, business, education, and/or the like. As a result, electronic devices are commonly carried by a user. In some instances, an electronic device may be placed in a carrying device, such as, for example, a bag, a purse, or the like.

Because of the materials used in constructing electronic devices, such devices may be susceptible to damage. For example, a device may become scratched, cracked, nicked, and/or the like. Such damage may result from mishandling, such as, for example, a user dropping the electronic device. As such, some users may opt to protect their electronic device from damage by placing a cover, a case, or a shield on the electronic device.

Manufacturers of electronic devices sometimes install speakers that are of poor quality and/or are unsuitable for their intended use, particularly in instances where an electronic device is located in a carrying device, a cover, a case, a shield, and/or the like. In some instances, the speakers may be perceived as having poor quality by a user or may not meet a user's expectations or desires. Thus, when the device rings or when the user attempts audio playback, video playback, or the like, the resulting sound may be muffled or not readily discernable. Previous attempts to solve this problem have included the manufacture of devices that are equipped with more powerful and/or better quality speakers and can receive an electronic device via a plug, an adaptor, a port, and/or the like. However, such speaker systems are costly, may be configured to connect to only certain types of electronic devices, may need to be approved by the electronic device manufacturer before they can be manufactured, may require a power source to function, may not be portable, may block various ports and/or connections on the electronic device, and/or may not be aesthetically pleasing.

Other attempts to solve the problem of poor quality speakers have included gramophone style devices that incorporate one or more of a waveguide and a flared sound amplifying portion. The flared sound amplifying portion may be, for example, horn or box shaped. However, such devices require specific placement of the speaker on the electronic device with the sound amplifying portion to ensure proper amplification of sound. Even slight misplacements of the electronic device may prevent the sound from being amplified properly. Furthermore, such devices typically have multiple parts that may break or become lost, which would render the device useless.

### SUMMARY

In an embodiment, a storage device for storing an electronic device is described. The storage device may include a projection device and an opening. The projection device may include a surface having a recess, wherein the recess is configured to reflect sound emitted from the electronic device, when located adjacent to the recess, to at least one area facing the surface. The opening in the storage device may be configured to allow for insertion of the electronic device into the recess such that the projection device is positioned in an interior portion of the storage device.

In another embodiment, a method of forming a storage device is described. The method may include providing a material, forming the material into a shape having a surface, forming a recess in the surface to produce a projection device, forming an opening in a storage material, and placing the projection device in the opening of the storage material to produce the storage device. When forming the recess, the recess may be configured to reflect sound emitted from an electronic device located adjacent to the recess to at least one area facing the surface.

### BRIEF DESCRIPTION OF THE DRAWINGS

FIG. 1 depicts a side perspective view of an illustrative sound-enhancing storage device according to an embodiment.

FIG. 2A depicts a rear elevational view of an illustrative sound-enhancing storage device according to another embodiment.

FIG. 2B depicts a front elevational view of the sound-enhancing storage device of FIG. 2A according to an embodiment.

FIG. 3 depicts a front elevational view of an illustrative sound-enhancing storage device according to another embodiment.

FIG. 4 depicts a cutaway view of an illustrative sound-enhancing storage device containing a projection device according to an embodiment.

FIG. 5A depicts a front perspective view of an illustrative projection device according to an embodiment.

FIG. 5B depicts a rear perspective view of an illustrative projection device according to an embodiment.

FIG. 5C depicts a side perspective view of an illustrative projection device according to an embodiment.

FIG. 5D depicts a side elevational view of an illustrative projection device according to an embodiment.

FIG. 6 depicts placement of an electronic device within a sound-enhancing storage device according to an embodiment.

FIG. 7A depicts a cutaway view of an electronic device placed within the sound-enhancing storage device in a first orientation proximate to a projection device according to an embodiment.

FIG. 7B depicts a cutaway view of an electronic device placed within the sound-enhancing storage device in a second orientation proximate to a projection device according to an embodiment.

FIG. 8 depicts a schematic diagram of a shape of a recess in a projection device according to an embodiment.

FIG. 9 depicts a flow diagram of an illustrative method of forming a sound-enhancing storage device according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device capable of creating or reproducing sound that includes a processing device and a tangible, computer-readable memory or storage device. The memory may contain programming instructions that, when executed by the processing device, cause the device to perform one or more operations according to the programming instructions. Illustrative examples of electronic devices include personal computers, gaming systems, televisions, and mobile devices.

A “mobile device” refers to an electronic device that is generally portable in size and nature. Accordingly, a user may transport a mobile device with relative ease. Illustrative examples of mobile devices include pagers, cellular phones, feature phones, smartphones, personal digital assistants (PDAs), cameras, tablet computers, phone-tablet hybrid devices (“phablets”), portable gaming devices, laptop computers, netbooks, ultrabooks, global positioning satellite (GPS) navigation devices, in-dash automotive components, media players, watches, and the like.

A “storage device” refers to any device or structure that is generally configured to hold and/or protect an electronic device therein. More particularly, a “sound-enhancing storage device” refers to any device or structure that, in addition to holding and/or protecting an electronic device, is further configured to amplify and/or redirect sounds emitted by the electronic device, project and/or redirect light emitted by the electronic device, and/or the like. Illustrative storage devices may include, but are not limited to, purses, clutches, satchels, handbags, shoulder bags, messenger bags, computer bags, briefcases, backpacks, diaper bags, coin purses, wallets, storage cases, protective cases, snap on covers, and/or the like.

The present disclosure relates generally to devices that are configured to hold and/or carry an electronic device such that when the electronic device emits a sound, emits light, and/or vibrates, the various sounds, vibrations, and/or light will not be muffled or otherwise indiscernible to the person carrying the device. Thus, the devices described herein may generally be used to amplify and/or redirect sounds, vibrations, and/or light emitted by the electronic device. In addition, the devices described herein may generally be portable such that a user can use such devices to easily transport one or more electronic devices. In some embodiments, the user may also use the devices described herein to easily transport other items in addition to the one or more electronic devices. In some embodiments, the user may also use the devices described herein to protect an electronic device.

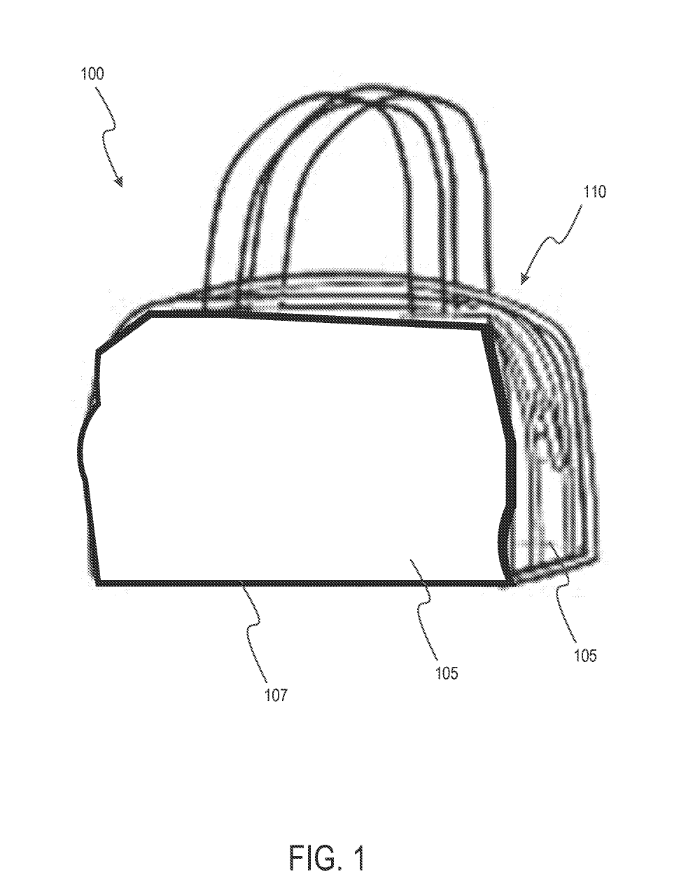

FIG. 1 depicts a perspective view of an illustrative sound-enhancing storage device, generally designated 100, according to an embodiment. The storage device 100 may generally have one or more faces 105 and an opening 110 therein. The storage device 100 may generally be made of any number or type of materials. Accordingly, the material used for the storage device 100 is not limited by this disclosure. Illustrative materials may include fabrics, leather, woven materials, wood, polymers, polymer-based materials, polymer-coated materials, paper, paper-based materials, metal, metal-based materials, metal-coated materials, and/or the like. In some embodiments, a portion of the storage device 100 may contain a particular material that is suited for passage of sound and/or light. For example, a portion of the storage device 100 may contain an acoustical fabric in an area in which an electronic device may be located when placed inside the storage device. The acoustical fabric may assist a projection device (as described in greater detail herein) in amplifying and/or redirecting sound waves emitted by an electronic device stored in the storage device 100. Thus, the acoustical fabric may facilitate passage of sound waves therethrough. In another example, a portion of the storage device may be made of a material that permits light emitted by an electronic device to be discernible outside of the storage device 100.

The storage device 100 may generally have any size and/or shape, subject to limitations specifically described herein. In some embodiments, the storage device 100 may be any color, including a combination of different colors. In some embodiments, at least one portion of the storage device 100 may be transparent or translucent such that a user is able to discern at least a portion of the storage device. In other embodiments, the storage device 100 may be opaque. In some embodiments, one or more portions of the storage device 100 may be opaque, while other portions are transparent. In some embodiments, various portions of the storage device 100 may contain one or more indicia, etchings, drawings, images, logos, and/or the like. The location and size of such indicia, etchings, drawings, images, logos, and/or the like are not limited by this disclosure, and may be of any size that is suitable for the storage device 100 and at any location on the storage device. For example, in some embodiments, the storage device 100 may have a logo, such as a corporate logo, on one of its faces 105.

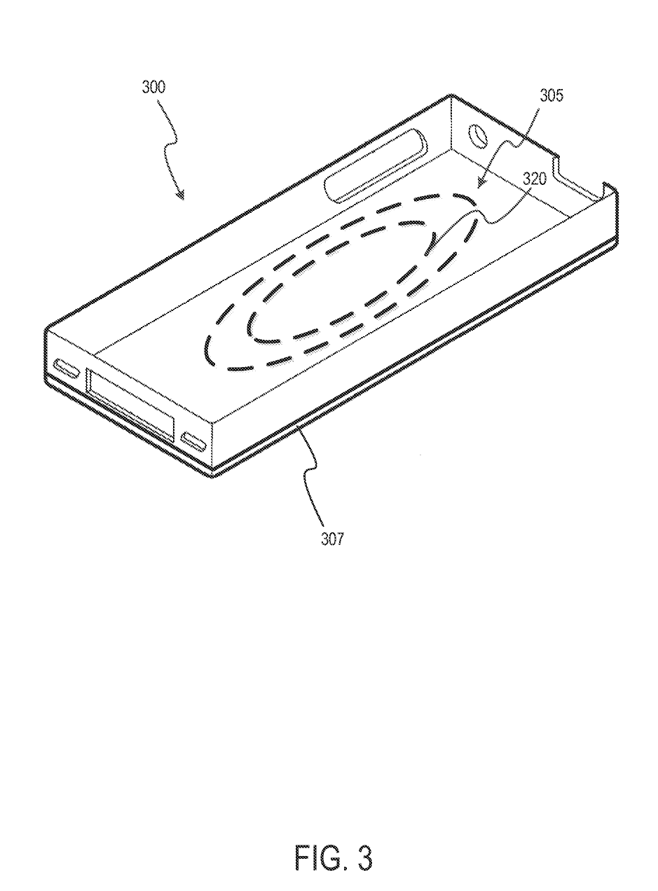

In various embodiments, the storage device 100 may have external windows, etchings, tubing, or the like 107 (or 307 in FIG. 3) such that, when the storage device contains an electronic device that activates a light source (such as a flash on the electronic device), the external windows, etchings, tubing, or the like are accentuated or illuminated by the light. In some embodiments, the external windows, etchings, tubing, or the like 107 (or 307 in FIG. 3) may be referred to as a light emitting device. Those having ordinary skill in the art will recognize that the term “external” refers to portions that are visible outside of the storage device 100. Thus, the external windows, etchings, tubing, or the like 107 (or 307 in FIG. 3) may be integrated within the interior of the storage device such that they allow light to propagate from one or more areas inside the storage device to one or more areas outside the storage device. Thus, in some embodiments, the external windows, etchings, tubing, or the like 107 may propagate light emitted by an electronic device, particularly an electronic device contained within the storage device 100. Accordingly, a user of the storage device 100 may be able to discern that the electronic device has an activated light source (such as, for example, an electronic device that lights up when it rings) without the need to remove the electronic device from the storage device 100. In some embodiments, the external windows, etchings, tubing, or the like 107 (or 307 in FIG. 3) may be constructed of a material that is suitable for propagating light. For example, the external windows, etchings, tubing, or the like 107 (or 307 of FIG. 3) may be constructed of a polymer material, a polymer-based material, a polymer-coated material, glass, and/or the like. Such external windows, etchings, tubing, or the like 107 (or 307 of FIG. 3) may be physically affixed to the storage bag 100, may be integrated with the storage bag, or may be detachable from the storage bag. In some embodiments, the external windows, etchings, tubing, or the like 107 (or 307 of FIG. 3) may be affixed or attached to the storage bag 100 such that, when an electronic device is placed in the bag, the windows, etchings, tubing, or the like is optically coupled to at least a portion of the electronic device, such as a light-emitting portion of the electronic device. Thus, the external windows, etchings, tubing, or the like 107 (or 307 of FIG. 3) need not be physically connected to the electronic device when it is placed in the storage bag 100. Rather, the external windows, etchings, tubing, or the like 107 (or 307 of FIG. 3) merely have a clear optical path to at least a portion of the electronic device such that light emitted by the electronic device is propagated as described herein. In some embodiments, the external windows, etchings, tubing, or the like 107 (or 307 of FIG. 3) may be configured to alter the light emitted by the electronic device. Alteration of the light is not limited by this disclosure and may include any type of optical alteration, including, but not limited to, altering a wavelength of a light, altering an intensity of the light, altering a direction of the light, altering a polarization of the light, and/or the like. Thus, the external windows, etchings, tubing, or the like 107 (or 307 of FIG. 3) may contain additional components to effect alteration of the light, including, but not limited to, filters, lenses, mirrors, polarizers, and/or the like. In some embodiments, the external windows, etchings, tubing, or the like 107 (or 307 of FIG. 3) may be configured to emit light from an attached light source (not shown) in addition to (or in lieu of) propagating the light emitted from the electronic device.

In various embodiments, the storage device 100 may incorporate various electrical components. Illustrative electrical components may include components that allow for charging and/or syncing of the electronic device when it is placed in the storage device 100. Thus, the storage device 100 may incorporate universal serial bus (USB) ports, micro-USB ports, mini-USB ports, networking (such as Ethernet) ports, 30-pin ports, Lightning® connector ports (Apple, Inc. Cupertino, Calif.), and/or the like. In some embodiments, the storage device 100 may be configured for wireless syncing/charging or may allow the electronic device to wirelessly sync or charge without being removed from the storage device. In some embodiments, the storage device 100 may be configured to be plugged into an electrical outlet.

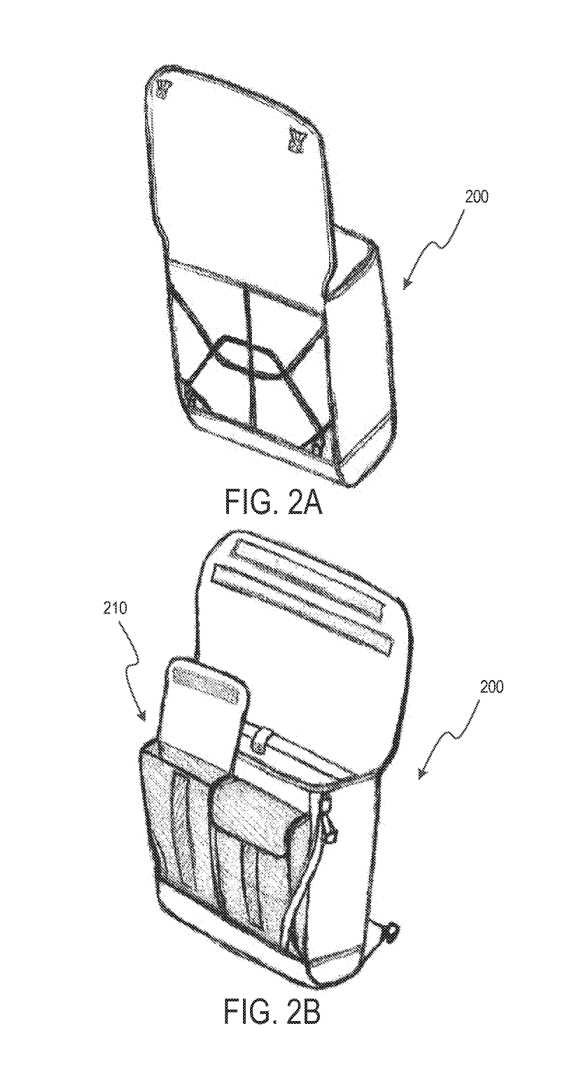

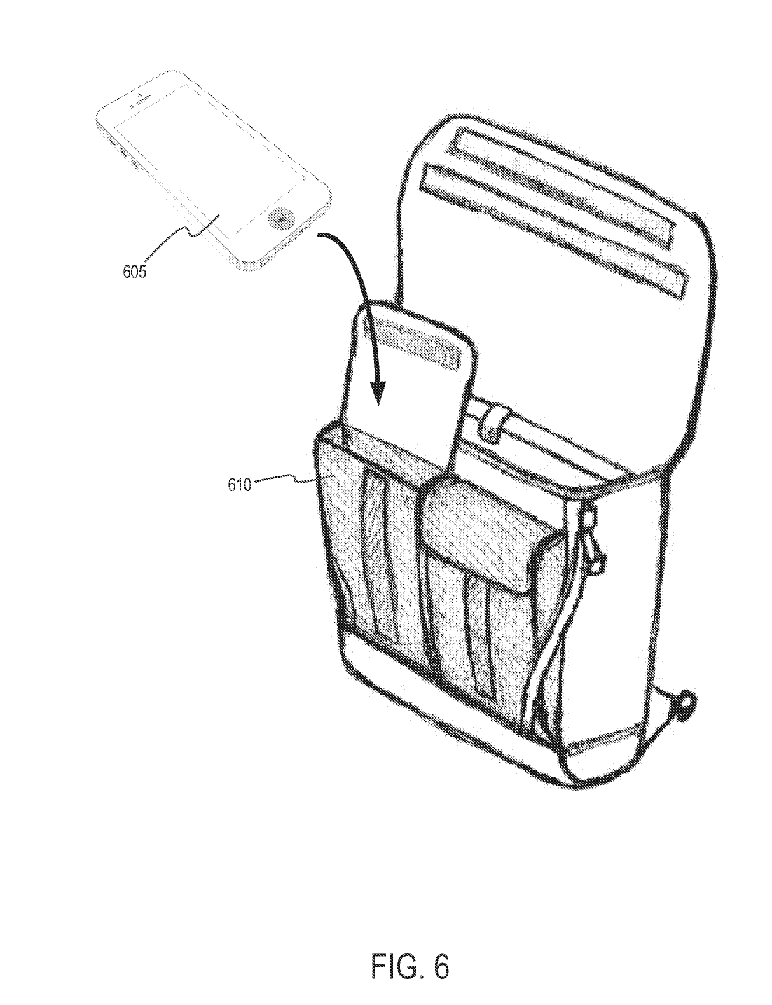

The opening 110 in the storage device 100 is not limited by this disclosure, and may generally be any opening configured to accept an electronic device and/or other items therein. In some embodiments, the opening 110 may be a closable opening, such as a zippered opening, snap opening, a hook-and-loop opening, a buttoned opening, and/or a magnetic opening. In some embodiments, the opening 110 may contain a flap. In some embodiments, the opening 110 may contain a sling for storing an electronic device therein such that the electronic device is separate from the remaining interior of the storage device 100 to allow for easy access. In some embodiments, the opening 110 may allow access to the entire interior of the storage device 100. In other embodiments, the opening 110 may only allow access to a portion of the storage device 100, such as a pocket or a section of the storage device. In some embodiments, the storage device 100 may contain a plurality of openings for multiple sections, pockets, and/or the like. For example, the storage device 200 depicted in FIGS. 2A and 2B contains a plurality of openings, such as a pocket 210. Thus, as shown in FIG. 6, an electronic device 605 may be placed inside an opening 610 of the storage device.

As shown in FIG. 3, in some embodiments, an opening 305 may be shaped and/or sized such that it is configured to hold an electronic device therein. In some embodiments, the opening 305 (and/or the storage device 300 as a whole) may be contoured to match an exact shape and/or size of the electronic device such that the storage device 300 can be tightly placed onto the electronic device. In other embodiments, the opening 305 may have a shape and/or size that is configured to contain a plurality of different electronic devices such that a user does not have to select a storage device 300 that is specific to his/her electronic device or so that the user can use the storage device interchangeably with a plurality of different electronic devices.

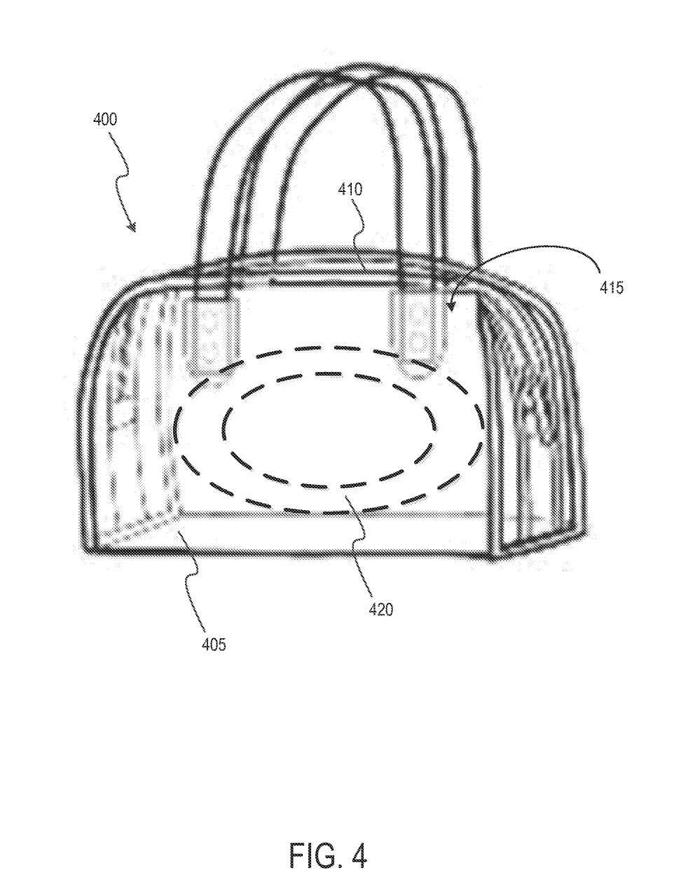

As shown in FIGS. 3 and 4, the storage device 300, 400 may contain one or more projection devices 320, 420. In some embodiments, the one or more projection devices 320, 420 may be integrated within the storage device 300, 400. In some embodiments, the one or more projection devices 320, 420 may be formed as a portion of the storage device 300, 400. In some embodiments, the one or more projection devices 320, 420 may be a separate piece that is placed within an opening 305, 405 of the storage device 300, 400. Each projection device 320, 420 may generally be configured such that, when an electronic device is placed adjacent to the projection device, the projection device amplifies and/or redirects sounds emitted by the electronic device. In some embodiments, each projection device 320, 420 may be arranged within the storage device 300, 400 such that, when a user places an electronic device inside the storage device, it is located suitably adjacent to the projection device for amplification and/or redirection. In some embodiments, the electronic device need not be specifically placed with respect to the projection device 320, 420. In other embodiments, the electronic device must be particularly placed and positioned with respect to the projection device 320, 420 to ensure appropriate amplification and/or redirection.

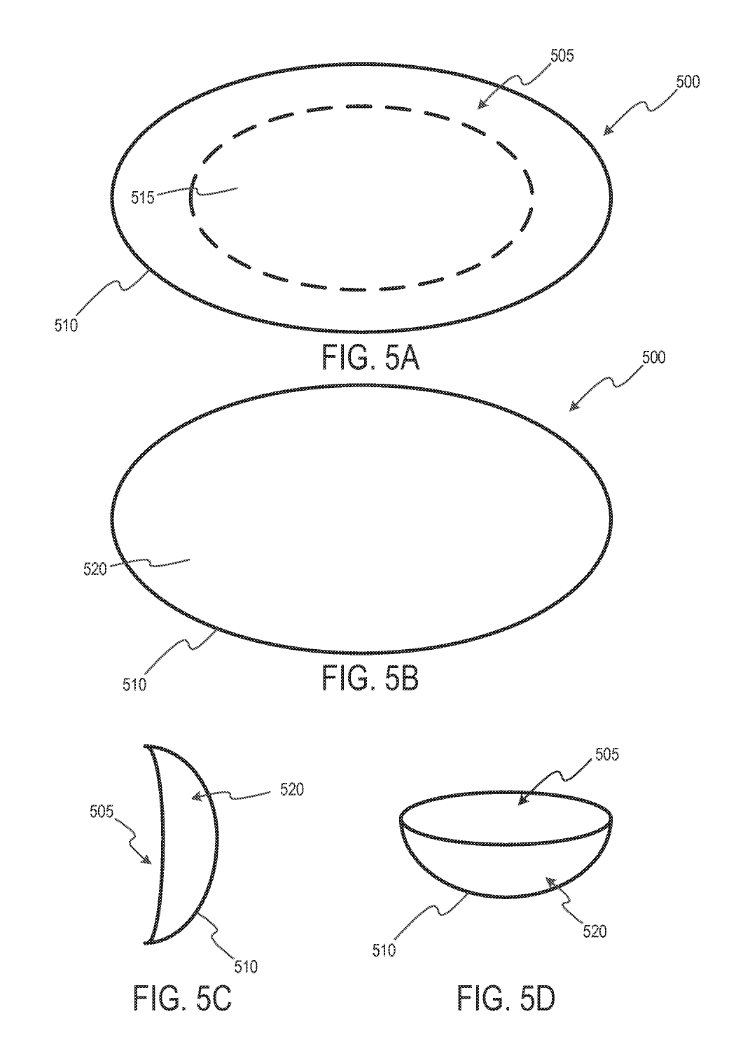

FIGS. 5A-5D depict various views of a projection device 500 according to various embodiments. The projection device may generally have at least a front face 505, a rear face 520, and an edge 510. Those having ordinary skill in the art will recognize that the projection device 500 may have additional faces and/or edges depending on the shape of the projection device. Accordingly, the shape depicted herein is nonlimiting.

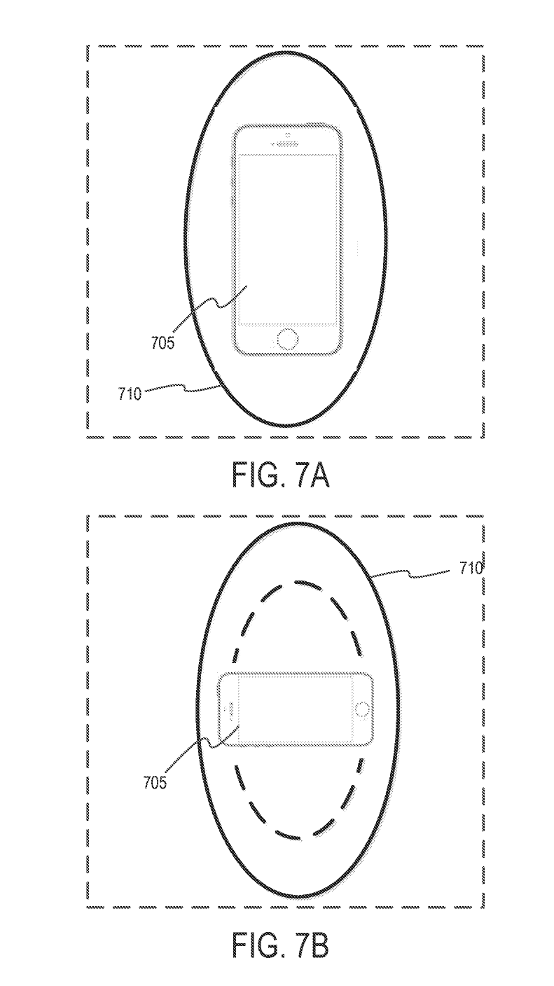

In various embodiments, the front face 505 may have a recess 515 therein. The recess 515 may be sufficiently shaped and/or sized such that an electronic device can be placed adjacent to the recess. In some embodiments, the electronic device may be placed in the recess 515. In other embodiments, the electronic device may be partially placed in the recess 515. As previously described herein, the orientation of the electronic device with respect to the recess 515 is not limited by this disclosure, and may include any orientation. For example, as shown in FIG. 7A, the electronic device 705 may be oriented in a portrait orientation with respect to the recess 710. In another example, as shown in FIG. 7B, the electronic device 705 may be oriented in a landscape orientation with respect to the recess 710. In some embodiments, the electronic device 705 may generally be oriented such that a speaker portion of the electronic device is adjacent to at least a portion of the recess 710. Accordingly, the recess 710 may reflect and/or amplify sounds emitted by the speaker portion of the electronic device 705, as described in greater detail herein. In some embodiments, the electronic device 705 may generally be oriented such that a microphone portion of the electronic device is adjacent to at least a portion of the recess 710 such that the recess reflects sound from an area surrounding the projection device and funnels the sound towards the microphone portion of the electronic device.

Referring again to FIGS. 5A-5D, the recess 515 may be configured such that the electronic device can be easily placed within the storage device adjacent to the recess and easily removed by a user. In some embodiments, easy placement may include allowing the user to place the electronic device at any location adjacent the recess 515 and still obtain various sound qualities described in greater detail herein. Thus, the positioning of the electronic device within the recess 515 may be irrelevant because the sound redirection and amplification will function regardless of the location of the electronic device within the storage device. Accordingly, a user can place the electronic device in the storage device without concern for whether the electronic device is in a particular location or orientation. Easy placement may further include a lack of movement or positioning of parts to ensure optimum sound quality as described in greater detail herein. Thus, a user may avoid time-consuming tasks such as specific placement of the electronic device, attachment of a sound reflecting device to the electronic device, ensuring proper positioning, placement, and orientation, and/or the like.

In various embodiments, the recess 515 may be shaped such that it mirrors the shape of the rear face 520 of the projection device. Accordingly, in some embodiments, the rear face 520 may also be substantially curved, as described herein. In other embodiments, the rear face 520 may be shaped independently of the recess 515, and may generally be any shape and/or size. For example, in some embodiments, the rear face 520 may have a substantially flat surface. In some embodiments, the rear face 520 may have a textured surface. In some embodiments, the rear face 520 may include indicia, an etching, a drawing, an image, a logo, and/or the like, as described in greater detail herein. In some embodiments, the rear face 520 may be omitted. In some embodiments, the rear face 520 may be shaped such that it provides a complementary shape to the storage device or such that the projection device 500 can be placed within the storage device.

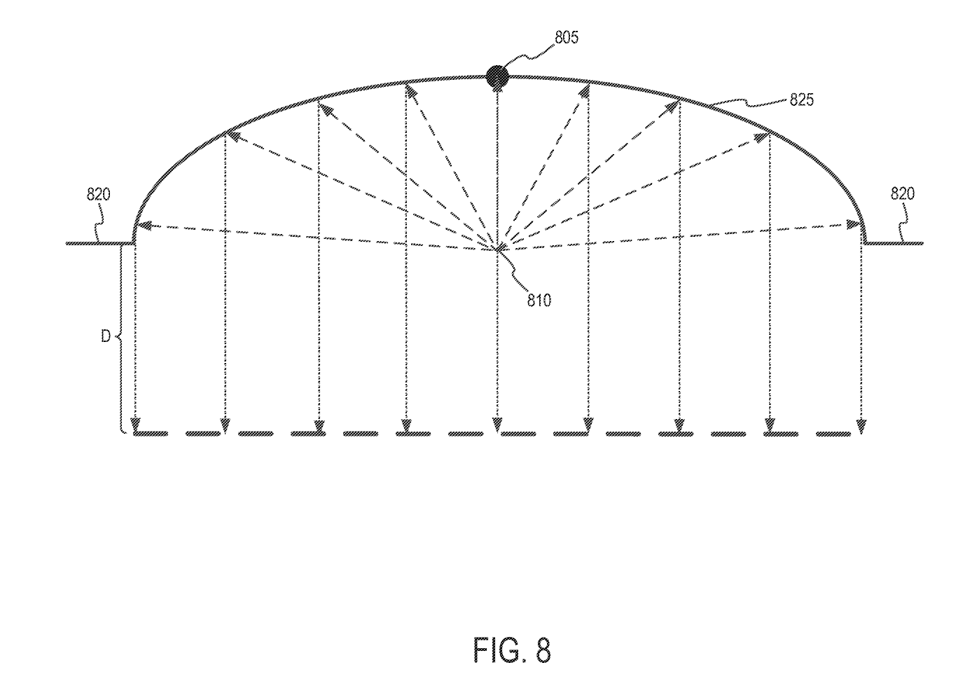

Referring to FIG. 8, the recess 825 may generally be shaped and/or sized such that any portion of the recess can reflect sound waves to and from an electronic device positioned within the storage device. Those with ordinary skill in the art will recognize various shapes and/or sizes of the recess 825 that cause the sound waves to be directed to a particular location, to be focused, to be scattered, to exhibit a rotunda effect, and/or the like. For example, in some embodiments, the recess 825 may be shaped and/or sized such that the storage device is configured to provide maximum reflection of sound for a particular electronic device with particular speaker and/or microphone placement. Maximum reflection of sound may be defined as sound reflection at a plurality of angles, such as, for example, a reflection angle of about 10° to about 180° in any direction from the recess 825 with respect to the surface of the recess, including about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or any value or range between any two of these values (including endpoints). Maximum reflection may also include reflection of sound waves up to a distance away from the storage device, as described in greater detail herein.

In various embodiments, the recess 825 may generally be shaped and/or sized such that any portion of the recess can amplify sound waves emitted by an electronic device positioned within the storage device. For example, a curved surface of the recess 825 may redirect and/or passively amplify sound. Those with ordinary skill in the art will recognize that any shape and/or size of the recess 825 can cause the sound from the electronic device to be amplified. For example, in some embodiments, the recess 825 may be shaped and/or sized such that the storage device amplifies the sound emitted from the electronic device about 1 decibel (dB) louder than the sound emitted from the electronic device without the storage device to about 100 dB louder, including about 1 dB, about 5 dB, about 10 dB, about 15 dB, about 20 dB, about 25 dB, about 50 dB, about 75 dB, about 100 dB, or any value or range between any two of these values (including endpoints). In some embodiments, the recess 825 may be shaped and/or sized such that it reflects any frequency of sound. Thus, the recess 825 avoids a known shortcoming of various other amplifiers, such as gramophone style devices, that reflect and/or amplify certain frequencies while failing to reflect and/or amplify other frequencies.

In some embodiments, the recess 825 may generally be shaped and/or sized such that any portion of the recess can absorb sound waves emitted by an electronic device positioned within the storage device and/or emitted from objects adjacent to the recess. In particular embodiments, the recess 825 may contain a coating, an insert, and/or the like to cause absorption of sound waves. In some embodiments, the recess 825 may be configured to absorb only certain frequencies of sound waves while reflecting other frequencies. For example, the recess 825 may be configured to absorb background noise at low frequencies while at the same time allowing human voices at higher frequencies to reflect and/or be amplified. Such a configuration may allow, for example, the storage device to be used successfully with the electronic device as a communications apparatus in noisy environments.

In various embodiments, the shape of the recess 825 may generally be curved. Curvature is not limited by this disclosure, and may be any regular or irregular curve. For example, one such shape of the recess 825 may be generally parabolic such that a vertex 805 of the parabola is located substantially near a center portion of the recess 825 and a focus 810 of the parabola is located at or near the surface 820. In some embodiments, the focus 810 of the curved recess may be located generally at a location where sound is emitted, such as, for example, at or near a speaker on the electronic device. A user situated in front of the storage device may be located at or near the focus, or may be located at a distance D away from the storage device. The distance D is not limited by this disclosure, and may be any reasonable distance that the sound waves emitted from the storage device may travel. Illustrative distances may include about 10 centimeters (cm) to about 10 meters (m), including about 10 cm, about 50 cm, about 1 m, about 2 m, about 3 m, about 4 m, about 5 m, about 6 m, about 7 m, about 8 m, about 9 m, about 10 m, or any value or range between any two of these values (including endpoints). Thus, when sound is emitted from an electronic device at the focus 810, it will reflect off the curved recess 825 towards a user, as indicated by the arrows.

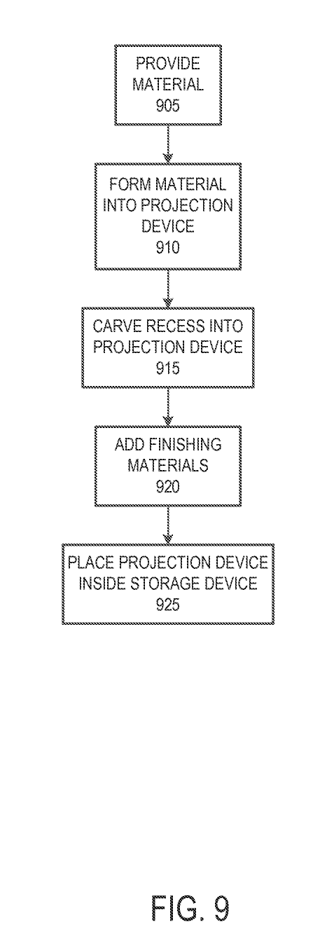

FIG. 9 depicts a flow diagram of a method of forming the storage device (including the projection device) according to an embodiment. In various embodiments, a material may be provided 905. The material may generally be a material suitable for the projection device portion, such as, for example, wood, polymer, polymer-based materials, polymer-coated materials, paper, paper-based materials, metal, metal-based materials, metal-coated materials, and/or the like. In some embodiments, providing 905 the material may include providing a solid block of material, providing a formable material such as a melted polymer, and/or the like.

In various embodiments, the material may be formed 910 into the projection device. Forming 910 the material into the projection device may include cutting, carving, whittling, tooling, sanding, buffing, injection molding, thermoforming, and/or the like. The material may generally be formed 910 into a shape and/or size that is desired for the projection device based on various characteristics described in greater detail herein. In some embodiments, a recess may be carved 915 into the projection device after the projection device is formed 910. In some embodiments, forming 910 may include carving 915 the recess into the projection device. In other embodiments, forming 910 may account for the recess so that no carving step is necessary, particularly in injection molding processes where a mold contains the recess. In some embodiments, forming 910 may include forming one or more separate components of the projection device.

In various embodiments, one or more finishing materials may be added 920 to the projection device and/or the storage device. Addition 920 of finishing materials may include any number of coatings, carvings, etchings, drawings, image and/or logo applications, stickers, decals, addition of ports, openings, and/or the like. In some embodiments, the one or more finishing materials may include various etchings, carvings, and/or the like that are configured for shadow casting. The projection device may be placed 925 inside the storage device such that the projection device is integrated with the storage device, as described in greater detail herein.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A storage device comprising:
a projection device comprising a surface having a recess, wherein the recess is configured to reflect sound emitted from an electronic device located adjacent to the recess to at least one area facing the surface; and
an opening configured to allow for insertion of the electronic device into the recess such that the projection device is positioned in an interior portion of the storage device.

2. The storage device of claim 1, further comprising a light emitting portion configured to propagate light emitted from the electronic device.

3. The storage device of claim 2, wherein the light emitting portion is further configured to alter and supplement the light emitted from the electronic device.

4. The storage device of claim 2, further comprising one or more external features configured to receive light from the light emitting portion such that light emitted by the electronic device is visible outside the storage device.

5. The storage device of claim 4, wherein the one or more external features comprise at least one of an external window, an etching, and a light tube.

6. The storage device of claim 1, wherein the recess is sized and shaped similar to the electronic device such that the electronic device fits securely in the recess.

7. The storage device of claim 1, wherein the projection device is removably inserted in the storage device.

8. The storage device of claim 1, further comprising at least one electrical component configured to provide power for charging the electronic device when the electronic device is placed in the recess.

9. A method of forming a storage device, the method comprising:
providing a material;
forming the material into a shape having a surface;
forming a recess in the surface to produce a projection device;
forming an opening in a storage material; and
placing the projection device in the opening of the storage material to produce the storage device,
wherein the recess is configured to reflect sound emitted from an electronic device located adjacent to the recess to at least one area facing the surface.

10. The method of claim 9, further comprising:
forming a light emitting device in the storage material, wherein the light emitting device is configured to propagate light emitted from the electronic device.

11. The method of claim 10, further comprising configuring the light emitting device to alter and supplement the light emitted from the electronic device.

12. The method of claim 10, further comprising producing one or more external features on the storage device, the one or more external features configured to receive light from the light emitting portion such that light emitted by the electronic device is visible outside the storage device.

13. The method of claim 12, wherein producing the one or more external features comprises producing at least one of an external window, an etching, and a light tube.

14. The method of claim 9, wherein forming the recess comprises sizing and shaping the recess similar to the electronic device such that the electronic device fits securely in the recess.

15. The method of claim 9, wherein placing the projection device in the storage device comprises removably inserting the projection device in the storage device.

16. The method of claim 9, further comprising providing at least one electrical component configured to provide power for charging the electronic device when the electronic device is placed in the recess.
